(19) United States
(12) Patent Application Publication
(10) Pub. No.: US 2002/0176816 A1
(43) Pub. Date: Nov. 28, 2002

(54) In-line sulfur extraction process

(76) Inventor: Strom W. Smith, Houston, TX (US)

Correspondence Address: KEELING LAW FIRM, 901 NORTH POST OAK ROAD, HOUSTON, TX, 77024-3845, US

(21) Appl. No.: 09/847,451

(22) Filed: May 2, 2001

(51) Int. Cl. C01B 17/04

(52) U.S. Cl. 423/574.1

(57) ABSTRACT

A method of removing hydrogen sulfide from a hydrocarbon stream such as natural gas or refinery off gas, including those from catalytic crackers, hydrocrackers, hydrotreaters, chemical plant processes, etc. Sulfur dioxide from an external source is directly introduced into the hydrocarbon stream to promote a Claus reaction to remove the hydrogen sulfide by converting it into elemental sulfur and water. The hydrocarbons in the stream are unaffected by the process.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of Invention This invention relates to a method of removing H₂S from hydrocarbon stream such as natural gas or refinery off gas, including those from catalytic crackers, hydrocrackers, hydrotreaters, chemical plant processes, etc. Specifically, the invention directly injects SO₂from an external source into the hydrocarbon stream to promote a Claus reaction to remove the H₂S.

2. Related Art The Claus reaction is well known in the art of removing H₂S from a hydrocarbon stream. The Claus reaction formula for removing H₂S by converting it into elemental sulfur is:

2H₂S +SO₂→1.5S₂+2H₂O

The sulfur dioxide (SO₂) serves as a “promoter” to convert the hydrogen sulfide (H₂S) into elemental gaseous sulfur (S₂) and steam (H₂O). The reaction can occur with or without a catalyst.

In the prior art, the hydrocarbon stream is first passed through an amine treater to remove the H₂S. The hydrocarbon stream passes up through a tray tower while liquid amine (typically methyl amine, di-ethyl amine, methyl-di-ethyl amine or DGA) flows down across the trays. The amine captures the H₂S, and this “rich” amine then passes through a stripper, where the H₂S is stripped off. The H₂S then undergoes the Claus reaction in a sulfur recovery unit (SRU) using SO₂ that has been formed from the oxidation of a portion of the stripped H₂S. The prior art oxidation of H₂S to form SO₂takes place at very high temperature (typically between 2,000° F and 3,000° F) and at low pressure (typically between 0.9 and 1.2 atmospheres). At these high temperatures, any residual hydrocarbons may crack, forming coke. This coke clogs up the system, and reduces the efficiency of the process. Further, there is typically a downstream post-oxidation residue of about 3% H₂S that must undergo additional treatment after the sulfur recovery unit. This residue is typically treated in the tail gas treating unit for conversion into SO₂or H₂S for use in the above described Claus reaction.

The prior art typically requires low pressures for a variety of reasons, most of which are due to the structure of the oxidation and reaction equipment used. This requires the hydrocarbon stream, which is typically at high pressure, to be reduced in pressure prior to processing. This low pressure results in low partial pressure of the reactants (partial pressure being a function of the reactant concentration and total pressure), making the gas phase Claus reaction less efficient compared to that efficiency found in a high pressure environment.

Further, the Claus reaction is reversible. That is, if sulfur is not pulled off after being formed, the reaction can be reversed to reform H₂S and/or SO₂.

Thus, the prior art requires the hydrocarbon stream to be internally manipulated by reducing its pressure, stripping off H₂S and oxidizing part of the H₂S to form SO₂, which oxidation step often requires burning part of the valuable hydrocarbon itself.

### BRIEF SUMMARY OF THE INVENTION

The present invention eliminates most of the process and problems described above. Since hydrocarbons do not react with H₂S or SO₂, by injecting the promoter SO₂ directly into the hydrocarbon (HC) stream, the Claus reaction occurs while the hydrocarbons in the hydrocarbon stream remain inert to the reaction. Since the present method does not require the oxidation of H₂S (as is common in the prior art), the method can take place under high pressure, typically between 5 and 30 ATM. Oxidation units (burners) in the industry typically operate at low pressure. By not having to oxidize the H₂S, the method can operate at high pressure since no oxidation (burning) is required of the H₂S. However, the method can operate at either high or low pressure, typically between 1 and 30 ATM. As there is no oxidation, there is minimal or no carbon cracking to form coke, soot, etc.

The modified Claus reaction of the present inventive method therefore is:

HC+2H₂S+SO₂→1.5S₂+2H₂O +HC

This process of removing H₂S from the HC stream can occur in any standard environment. Preferably, the inventive process occurs in essentially two steps for optimal efficiency. In Step 1, the modified Clause reaction occurs on a first catalyst bed, which typically contains micro-porous pellets that adsorb the elemental liquid sulfur, and allow the water and hydrocarbon to pass through. Eventually, the first catalyst bed becomes saturated (clogged) and must be flushed out. This flushing occurs in Step 2, which takes heated hydrocarbons and water from a second catalyst bed to flush out the first catalyst bed. The flushed sulfur is allowed to cool to a liquid and be pulled off, while the hydrocarbon and water pass on for further treatment. In the preferred embodiment, the liquid sulfur is trapped in a sulfur trap as described in the Smith U.S. Pat. No. 5,498,270, issued Mar. 12, 1996. By opening and closing appropriate valves, the same process is used to flush out the second catalyst bed when it becomes saturated.

Alternatively, the process may occur in any standard process environment, including but not limited to a straight through Claus catalytic reactor system.

Accordingly, the objectives of this invention are to provide, inter alia, a new and improved method of removing H₂S from a hydrocarbon stream that:

can be performed at high pressure;

does not require high temperature, and thus does not oxidize any components in the hydrocarbon stream;

does not involve oxidation of H₂S to form SO₂;

requires less equipment than that of prior art;

minimizes the potential for a reverse Claus reaction; and

is cost effective.

These objectives are addressed by the inventive method. Other objects of the invention will become apparent from time to time throughout the specification hereinafter disclosed.

### BRIEF DESCRIPTION OF THE DRAWINGS

FIG. 1 depicts the first step of removing sulfur from a hydrocarbon stream using a first catalytic bed.

FIG. 2 depicts the second step of flushing sulfur from the first catalytic bed.

FIG. 3 depicts the combined system having multiple catalytic beds and their preferred connective piping and mechanical equipment.

FIG. 4 depicts the inventive process used in a straight through Claus catalytic reactor system.

### DETAILED DESCRIPTION OF THE INVENTION

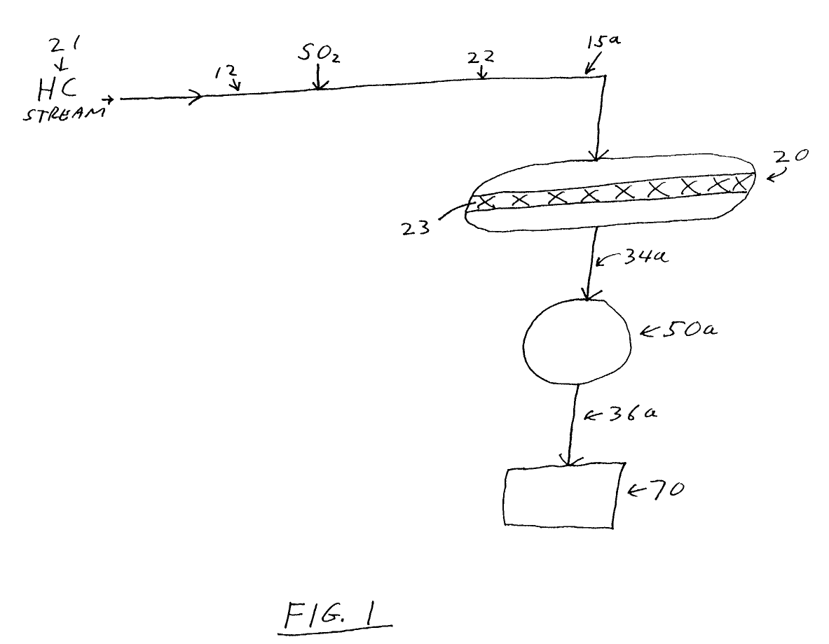

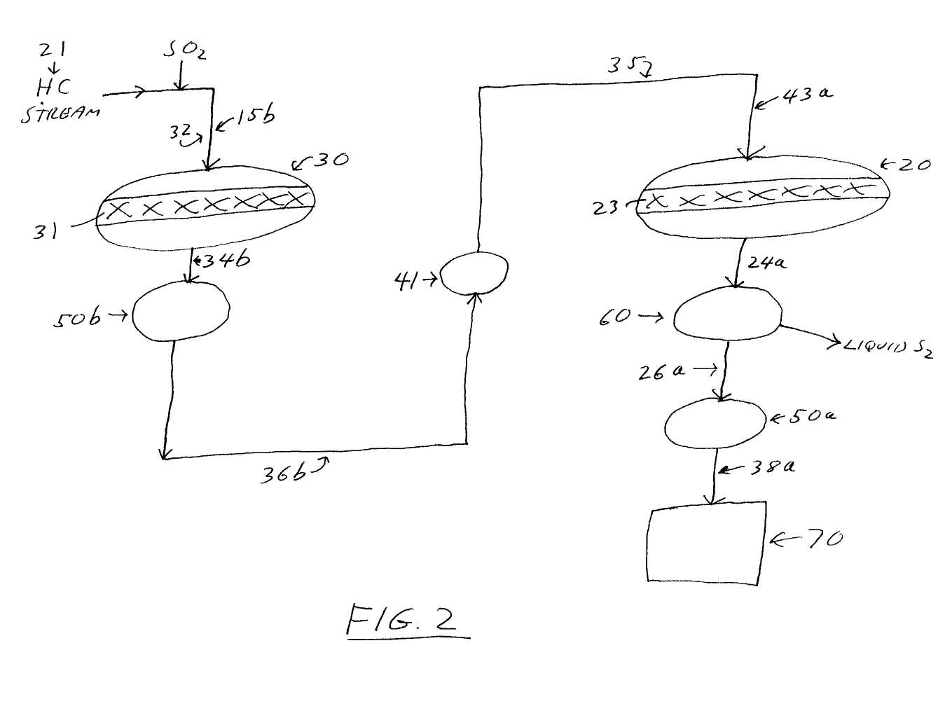

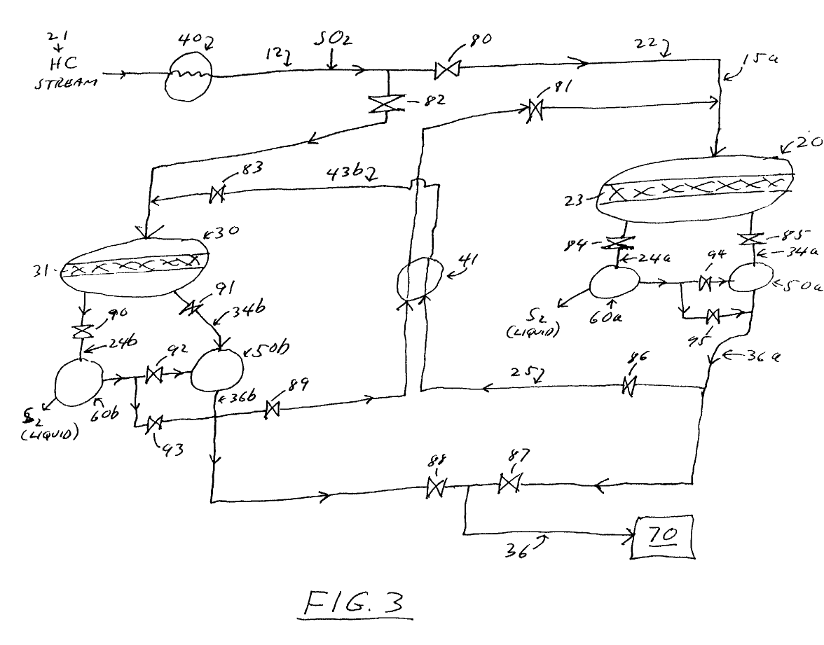

The present invention is described as system 10, depicted in a preferred embodiment in FIG. 3. System 10 comprises the steps depicted in block form in FIGS. 1 and FIG. 2. Note that the essential feature of system 10 is that SO₂from an external source is directly introduced into the HC stream to promote the equation:

HC+2H₂S+SO₂→1.5S₂+2H₂O+HC

The H₂S is thus removed from the HC stream in the form of elemental sulfur without manipulating the HC itself or stripping off the H₂S to form SO₂by oxidation. In the best mode, the amount of SO₂ introduced into the HC stream (containing H₂S) is slightly less than a 1:2 ratio of SO₂:H₂S. This ensures complete use of the SO₂ to prevent SO₂ in the downstream, which can be problematic (such as the formation of SO₃and/or H₂SO₄). However, the H₂S:SO₂ ratio can be adjusted according to the needs of the system and operator, depending on what residue of H₂S or SO₂can be tolerated or are desired downstream.

As depicted in FIG. 1, in the preferred embodiment the first step of system 10 is the removal of H₂S from inlet hydrocarbon stream 21 using the promoter SO₂in a Claus reaction. Inlet hydrocarbon stream 21 may be refinery off gas, petrochemical or chemical plant off gas, natural gas or any other hydrocarbon stream in which H₂S is to be removed. Hydrocarbon stream 21 comprises hydrocarbon(s) (HC) and H₂S, with the H₂S typically of a concentration between 3% and 20%, depending on the source of inlet hydrocarbon stream 21 and its make-up.

Inlet hydrocarbon stream 21 enters system 10 via main inlet line 12. In the preferred embodiment, if inlet hydrocarbon stream 21 is less than 260° F, it is heated in heat exchanger 40 to a temperature between 260° F and 300° F to prevent sulfur in inlet hydrocarbon stream 21 from solidifying. SO₂is then introduced into main inlet line 12 to combine with hydrocarbon stream 21 form process stream 15a, which comprises HC, H₂S and SO₂. The introduced SO₂is produced from an external source, typically a nearby SO₂generating unit that uses any SO₂producing method known in the art of chemical and petrochemical processing.

Process stream 15a continues through first inlet line 22 into first catalytic reactor 20, which comprises first catalyst bed 23. On first catalyst bed 23, the H₂S in process stream 15a reacts with the SO₂, following the equation of the exothermic Claus reaction:

$$HC + 2 {H}_{2} S + {SO}_{2} {\to }_{ catalyst } 1.5 {S}_{2} + 2 {H}_{2} O + HC$$

It is significant that the HC does not react and is not structurally affected by first catalyst bed 23.

The catalyst in first catalyst bed 23 typically comprises catalyst beads, which comprise alumina, activated charcoal, or aluminum carbonate (AL₂CO₃). The catalyst beads are typically ⅛″ to ⅜″ diameter beads having a high porosity for absorbing and/or adsorbing condensed elemental sulfur.

Because the Claus reaction is exothermic, in the preferred embodiment first catalyst bed 23 is cooled, typically using cooling coils, to promote the reaction, which is more efficient at temperatures just above the freezing point of sulfur (248° F). Further, cooling catalyst bed 23 promotes the condensation of the sulfur to a liquid. The preferred range of temperature of first catalyst bed 23 is between 250° F and 280° F.

Desulfured process stream 34a, comprising HC, H₂O, S₂vapor and trace amounts of H₂S (typically 100 to 1000 ppm) leaves first catalytic reactor 20, and enters vaporous sulfur recovery unit 50a, where S₂vapor is removed using any device and/or method for capturing sulfur vapor known in the art, including absorbing dry beds or liquid processing systems.

Leaving vaporous sulfur recovery unit 50 is devapored process stream 36a , which comprises HC, H₂O and trace amounts of H₂S. Devapored process stream 36a may optionally then proceed to further treatment unit 70, depending on regulatory or process requirements. For example, further treatment unit 70 may perform dehydration to remove the H₂O, or further treatment unit 70 may remove or lower the concentration of trace amounts of H₂S, using any process for lowering H₂S concentrations known either in the prior art (including an amine unit) or taught by the inventive system 10.

When first catalyst bed 23 becomes saturated with liquid S₂, the S₂is flushed out as depicted in FIG. 2. Inlet HC stream 21 mixes with SO₂, typically after inlet HC stream 21 is heated in heat exchanger 40. By closing valve 80 and opening valve 82 shown in FIG. 3, the mixture of inlet HC stream 21 and SO₂passes through second inlet line 32 as process stream 15b (comprising HC, H₂S and SO₂) into second catalytic reactor 30, where it reacts in a Clause reaction on second catalytic bed 31. Typically, second catalytic reactor 30 and second catalytic bed 31 comprise the same structure, temperature control and catalytic beads described above for first catalytic reactor 20 and first catalytic bed 23. Liquid sulfur remains in and/or on second catalytic bed 31, and desulfured process stream 34b, comprising HC, H₂O, a small amount of vapor sulfur and a trace amount of H₂S, leaves second catalytic reactor 30 and enters vaporous sulfur recovery unit 50b. Typically vaporous sulfur recovery unit 50b is structurally and functionally equivalent to vaporous sulfur recovery unit 50a. Leaving vaporous sulfur recovery unit 50b is devapored process stream 36b, comprising HC, H₂O and trace amounts of H₂S. Devapored process stream 36b passes through and is heated to a preferred temperature between 380° F and 420° F in heat exchanger 41, which is preferably a shell tube cross heat exchanger for recovering downstream heat from desulfured wash stream 26a and/or devapored wash stream 38a described below. Heated devapored process stream 36b then passes through first flush line 35 as inlet flush stream 43a (the heated stream of HC, H₂O and trace amounts of H₂S). Inlet flush stream 43a passes across the catalyst beds of first catalyst bed 20, flushing out the liquid S₂. Sulfur rich wash stream 24a coming from first catalyst bed 20 comprises HC, H₂O, liquid S₂ and trace amounts of H₂S (typically 100 to 1000 ppm). Sulfur rich wash stream 24a enters liquid sulfur recovery unit 60a, which is any liquid sulfur recovery device known in the art of chemical and petrochemical processing, including the sulfur trap described by Smith in U.S. Pat. No. 5,498,270, issued Mar. 12, 1996. The liquid sulfur is eventually removed from liquid sulfur recovery unit 60a. Leaving liquid sulfur recovery unit 60a is desulfured wash stream 26a, which comprises HC, H₂O, small amounts of S₂vapor, and trace amounts of H₂S. In the preferred embodiment, desulfured wash stream 26a passes through vaporous sulfur recovery unit 50a to remove the small amounts of S₂vapor. Devapored wash stream 38a, comprising HC, H₂O and trace amounts of H₂S, leaves vaporous sulfur recovery unit 50a for further processing, if necessary, in further treatment unit 70, as described above for devapored process stream 36a .

When first catalytic reactor 20 has been flushed of liquid S₂, appropriate valves are opened and closed to allow first catalyst bed 23 to start removing H₂S from process stream 15a as described above. The desulfured process stream 34a from first catalytic reactor 20 can then be used to flush out second catalyst bed 31 in an analogous manner to the process described above and depicted in FIG. 2 for first catalyst bed 23.

Valves 80-95 can be opened and closed in a wide range of permutations. One such setting may allow one or both desulfured process streams 34a and 34b to be released downstream, either through or around further treatment unit 70. While it is essential that liquid sulfur recovery unit 60 remove the flushed liquid sulfur from either catalytic reactor, vaporous sulfur recovery units 50 may be circumvented.

Further, while FIG. 3 shows only a first catalytic reactor 20 and a second catalytic reactor 30 with associated piping, heaters, and vapor and liquid sulfur traps, it is understood that more than two catalytic reactors may be utilized in the same interacting manner described above for just two reactors.

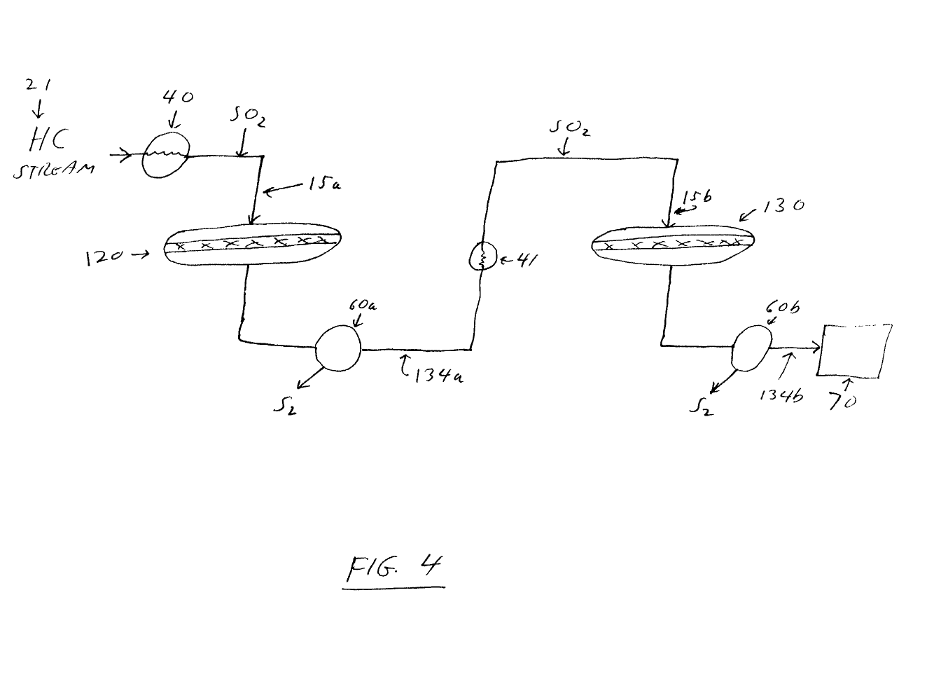

Alternatively, system 10 may be used in any process environment capable of introducing into the hydrocarbon stream a desired amount of SO₂from an external source to remove H₂S from that hydrocarbon stream without manipulating the hydrocarbon itself. For example, system 10 may be used in a straight through Claus catalytic reactor system, as depicted in FIG. 4. HC stream 21 is heated in heat exchanger 40 and then passes through first pass through catalytic reactor 120. Unlike first catalytic reactor 20 described above, first pass through catalytic reactor 120 does not absorb the elemental sulfur produced in the Claus reaction, but allows the sulfur to pass through to a first liquid sulfur recovery unit 60a, where the sulfur is pulled out of process stream 15a leaving desulfured process stream 134a. Desulfured process stream 134a typically still has some residual H₂S, so desulfured process stream 134a is reheated in heat exchanger 41, additional SO₂ from an external source is introduced to form process stream 15b,which reacts in second pass through catalytic reactor 130. Sulfur is pulled off in liquid sulfur recovery unit 60b, and desulfured process stream 134b continues to further treatment unit 70, which may be a dehydrator, amine unit or additional Claus catalytic reactors as described herein.

The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

I claim:

1. A method for removing hydrogen sulfide from a hydrocarbon stream, said method comprising:
injecting sulfur dioxide from an external source into said hydrocarbon stream; and
forming elemental sulfur from said hydrogen sulfide and said sulfur dioxide in a Claus reaction.

2. The method as in claim 1, said forming step occurring on a first catalytic reactor comprising a first catalyst bed.

3. The method as in claim 1, further comprising:
heating said hydrocarbon stream prior to said sulfur dioxide injection step.

4. The method as in claim 3, wherein said hydrocarbon stream is heated in the range of 260° F. and 300° F.

5. The method as in claim 1, further comprising:
removing a vaporous elemental sulfur from a first desulfured hydrocarbon process stream leaving said first catalytic reactor.

6. The method as in claim 1, further comprising:
forming elemental sulfur from said hydrogen sulfide and said sulfur dioxide in a second catalytic reactor comprising a second catalyst bed;
forming a first flush stream by heating a second desulfured hydrocarbon process stream leaving said second catalytic reactor; and
flushing said first catalyst bed with said first flush stream to wash said elemental liquid sulfur from said first catalyst bed.

7. The method as in claim 6, further comprising:
heating said first flush stream.

8. The method as in claim 7, wherein said first flush stream is heated in the range of 380° F.-420° F.

9. The method as in claim 6, further comprising:
removing said elemental liquid sulfur from a sulfur rich wash stream, said sulfur rich wash stream resulting from said first flush stream washing said elemental liquid sulfur from said first catalyst bed.

10. The method as in claim 9, further comprising:
removing an elemental vaporous sulfur from said sulfur rich wash stream.

11. The method as in claim 1, wherein said first catalyst bed comprises a plurality of catalyst beads.

12. The method as in claim 11, wherein said catalyst beads are chosen from a group consisting of alumina, activated charcoal, and aluminum carbonate.

13. The method as in claim 6, further comprising:
forming a second flush stream by heating a first desulfured hydrocarbon process stream leaving said first catalytic reactor, and
flushing said second catalyst bed with said second flush stream to remove said elemental liquid sulfur.

14. A method for removing hydrogen sulfide from a hydrocarbon stream, said method comprising:
injecting sulfur dioxide from an external source into said hydrocarbon stream; and
forming elemental sulfur from said hydrogen sulfide and said sulfur dioxide in a Claus reaction.

15. The method as in claim 14, further comprising:
passing said hydrocarbon stream through a liquid sulfur recovery unit to remove said elemental sulfur.

16. The method as in claim 14, further comprising:
passing said hydrocarbon stream through a catalytic reactor; and
subsequently passing said hydrocarbon stream through a liquid sulfur recovery unit to remove said elemental sulfur.
